(19) United States
(12) Patent Application Publication
(10) Pub. No.: US 2023/0271364 A1
(43) Pub. Date: Aug. 31, 2023

(54) AN APPARATUS AND A METHOD TO PREDICT THE REMAINING USEFUL LIFE OF A PLASTICIZING SCREW

(71) Applicant: MILACRON LLC, Cincinnati, OH (US)

(72) Inventors: Stefan Georg HILD, Langnau am Albis (CH); Severin Kin Yuen PANG, Zürich (CH); Christopher FUGATE, Ludlow, KY (US); Edward Lee JUMP, Jr., Independence, KY (US); Dan John LILLBACK, Cincinnati, OH (US)

(21) Appl. No.: 17/768,772

(22) PCT Filed: Oct. 14, 2020
(86) PCT No.: PCT/US2020/055528

§ 371 Date: Apr. 13, 2022

Related U.S. Application Data
(60) Provisional application No. 62/915,289, filed on Oct. 15, 2019.

(51) Int. Cl. B29C 45/77

(52) U.S. Cl. CPC B29C 45/77; B29C 2945/76006; B29C 2945/76026; B29C 2945/76187

(57) ABSTRACT

A method to predict the remaining useful life of a plasticizing screw for an injection molding machine is provided. The method comprises: creating an energy-pressure ratio distribution estimate for normal operation of the screw for a mold; creating a temporally local energy-pressure ratio distribution estimate from real time data for the screw for the mold; comparing the local distribution with the distribution for normal operation; and generating an alert if the comparison of the two distributions predicts that the remaining useful life is negligible.

### FIELD

The invention relates generally to an apparatus and a method to predict the remaining useful life of a plasticizing screw, and in particular, to an apparatus and a method to predict the remaining useful life of a plasticizing screw using adaptive learning.

### BACKGROUND

Plastic injection molding uses a plasticizing screw to plasticize plastic pellets into moldable plastic. Being able to predict the remaining useful life of a plasticizing screw is desirable.

### BRIEF SUMMARY

In an illustrated embodiment, a method to predict a remaining useful life of a plasticizing screw for an injection molding machine is provided. The method comprises: creating an energy-pressure ratio distribution estimate for normal operation of the screw for a mold; creating a temporally local energy-pressure ratio distribution estimate from real time data for the screw for the mold; comparing the local distribution with the distribution for normal operation; and generating an alert if the comparison of the two distributions predicts that the remaining useful life is negligible.

### BRIEF DESCRIPTION OF THE DRAWINGS

FIG. 1 is a schematic view of a method to predict the remaining useful life of a plasticizing screw, according to an embodiment of the present application.

### DETAILED DESCRIPTION

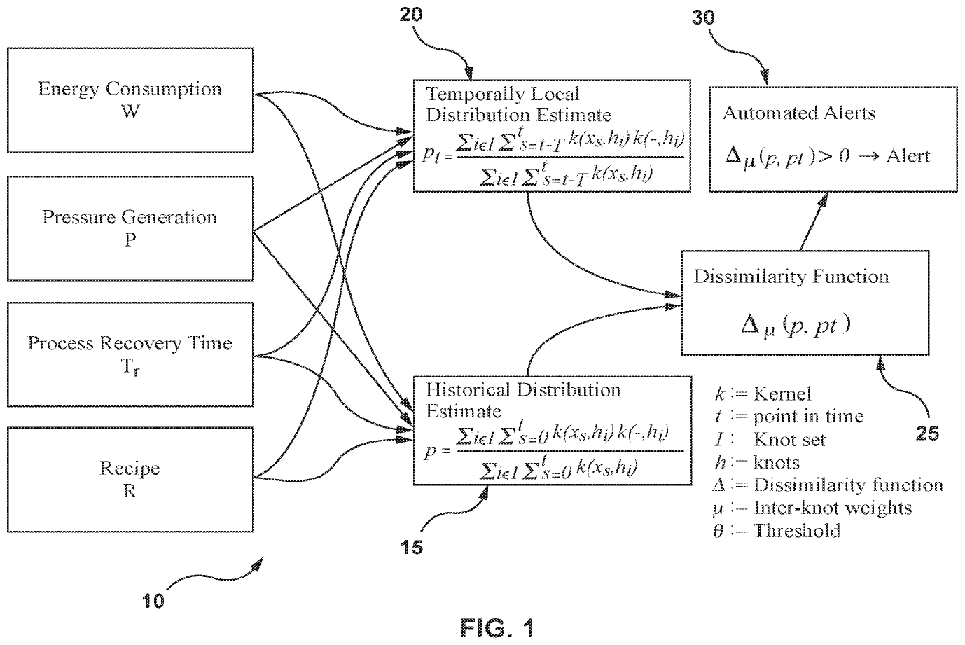

FIG. 1 depicts a schematic view of a method to predict the remaining useful life of a plasticizing screw, generally indicated by 10. Method 10 comprises: creating an energy-pressure ratio distribution estimate for normal operation of the screw for a mold, as indicated by block 15; creating a temporally local energy-pressure ratio distribution estimate from real time data for the screw for the mold, as indicated by block 20; comparing the local distribution with the distribution for normal operation, as indicated by block 25; and generating an alert if the comparison of the two distributions predicts that the remaining useful life is negligible, as indicated by block 30. The input to blocks 15 and 20 are energy consumption W by the screw, pressure generation P by the screw, process recovery time Tᵣ, and recipe R.

Pressure sensors in the injection molding machine can be used to measure the pressure P of the plastic produced by the screw. The energy consumption W used to operate the screw to generate the pressure generation P can be measured by measuring the mechanical energy applied to the motor drive.

In creating the energy-pressure ratio distribution estimate, data is collected over a selected number of injection cycles. The collected data is first subjected to a data cleansing operation to remove noise caused by the environment. Data cleansing can be effected by adaptive statistical methods based on statistical tools (e.g., running averages), but are adapting to environmental conditions through a feed-back loop that adjusts the amount of cleansing applied to the noise conditions detected by the algorithm. Consequently, in high-noise environments more cleansing is applied than in low-noise conditions. The cleansing is tuned to preserve the data detail required for further analysis. For example, a raw time-series sensor reading such as S=[s1, s2, s3, . . . sn] is cleaned by removing outliers that are outside a given band around the running average of S, whereby the width of the band and the length of the running average calculation is varied and adjusted based on environmental conditions.

The ratio of energy exerted on the screw (measured by mechanical energy applied to the motor drive) over the pressure created by the screw motion is expected to be equal, i.e. e/p=k. This equation can be augmented based on observations which will yield additional factors to account for material deviation (e.g., density or viscosity fluctuations of the granulate used). Once established, further deviations visible after cleansing are indicative of a deteriorating screw actions. Heuristics can be applied to each reading. Time is a dimension that deserves special treatment. Values that are out of range suddenly are treated differently than values that slowly drift over time.

The set can be extended by adding 1st derivative information to the time series, indicating a rate of change. Running average calculation is used to smooth this data.

The set can also be enhanced with spectrum information based on an FFT calculation over the time series data, indicating recurring frequencies within the measured data.

The historical distribution estimate can be created by either by engineering analysis, or by adaptively learning historically correct patterns using machine learning, or by some other means. For example, the following can be used to create the historical distribution estimate:

```
$P ( \cdot \vert T ) = \frac{1}{\vert {I}_{T} \vert} {\sum }_{j ∈ {I}_{T}} {\sum }_{i} {δ}_{{\vec{x}}_{j} ∈ {B}_{i}} {δ}_{\cdot ∈ {B}_{i}}$
$P ( \cdot ) = \frac{1}{\vert I \vert} {\sum }_{j ∈ I} {\sum }_{i} {δ}_{{\vec{x}}_{j} ∈ {B}_{i}} {δ}_{\cdot ∈ {B}_{i}}$
$Δ ( P , Q ) = arg {min}_{f} {\sum }_{k} {\sum }_{l} {D}_{k , l} {f}_{lk}$
s.t. δᵢfᵢₗ = P(Bₗ), δᵢfₖ_{ᵢ} = Q(Bₖ)
      δ := Kronecker delta
      B := space partitions
      I := index set
      Δ := Dissimilarity function
      D := Inter-partition distances [symbol]
  _{≥ 0} [symbol]    f := Inter partition flows
```

The above method can be used to create a historical distribution estimate from data collected from a normal operation (i.e., where the screw is functioning properly) (i.e., block 15). The same technique can also be used to create a temporally local distribution estimate based on real time data (i.e., block 20). The historical distribution estimate can be compared to the temporally local distribution estimate using a dissimilarity function (i.e., block 25):

Δμ(p,pt)

In the event that the dissimilarity function outputs a result greater than a threshold θ, an alert is generated (i.e., block 30).

Alert levels can be based on percentile abnormality, whereby abnormality is a quantified measure of the current data against historical distribution estimate. Thus, a small deviation over long periods of time is equivalent to a large deviation over a short period of time. The deviation is put in context to deviation typically seen on same/similar installations, and alerts levels are based on percentiles within that distribution. For example, if a particular deviation is larger than 80% of all comparable deviations, and particular alert level can get triggered.

Method 10 is a multi-dimensional probability distribution function. Block 20 computes the specific behaviour experienced recently, which can be the last cycle, the behaviour of recent period of time, or slightly longer. Method 10 considers the energy balance of the process—energy applied vs pressure generated—as key variables.

Method 10 can be performed by a computer, a networked of computers, or on the controller of the injection molding machine.

What is claimed is:

1. A method to predict a remaining useful life of a plasticizing screw for an injection molding machine, the method comprising:
creating an energy-pressure ratio distribution estimate for normal operation of the plasticizing screw for a mold;
creating a temporally local energy-pressure ratio distribution estimate from real time data for the plasticizing screw for the mold;
comparing the local energy-pressure ratio distribution estimate with the energy-pressure ratio distribution estimate for normal operation; and
generating an alert if the comparison of the two distributions predicts the remaining useful life is negligible.

2. The method of claim 1, wherein an input to the energy-pressure ratio distribution estimate for normal operation includes an energy consumption of the screw.

3. The method of claim 1, wherein an input to the energy-pressure ratio distribution estimate for normal operation includes a pressure generated by the screw.

4. The method of claim 1, wherein an input to the energy-pressure ratio distribution estimate for normal operation includes a process recovery time.

5. The method of claim 1, wherein an input to the energy-pressure ratio distribution estimate for normal operation includes a recipe.

6. The method of claim 1, wherein an input to the energy-pressure ratio distribution estimate for normal operation includes an energy consumption of the screw, a process recovery time, a pressure generated by the screw, and a recipe.

7. The method of claim 6 further comprising removing outliers from the real time data.

8. The method of claim 1, wherein an input to the local energy-pressure ratio distribution estimate includes an energy consumption of the screw.

9. The method of claim 1, wherein an input to the local energy-pressure ratio distribution estimate includes a pressure generated by the screw.

10. The method of claim 1, wherein an input to the local energy-pressure ratio distribution estimate includes a process recovery time.

11. The method of claim 1, wherein an input to the local energy-pressure ratio distribution estimate includes a recipe.

12. The method of claim 1, wherein an input to the local energy-pressure ratio distribution estimate includes an energy consumption of the screw, a process recovery time, a pressure generated by the screw, and a recipe.

13. The method of claim 12 further comprising removing outliers from the real time data.

14. The method of claim 1, wherein the comparing the local energy-pressure ratio distribution estimate with the energy-pressure ratio distribution estimate for normal operation includes using a dissimilarity function.

15. The method of claim 1, wherein the generating the alert includes basing alert levels on percentile abnormality, whereby abnormality is a quantified measure of the real time data against the energy-pressure ratio distribution estimate for normal operation.
